(19) United States
(12) Patent Application Publication
(10) Pub. No.: US 2022/0286923 A1
(43) Pub. Date: Sep. 8, 2022

(54) APPARATUSES AND METHODS FOR DELIVERY OF INTER-SYSTEM NON-ACCESS STRATUM (NAS) SECURITY ALGORITHMS

(71) Applicant: MediaTek Singapore Pte. Ltd., Singapore (SG)

(72) Inventors: Jarkko ESKELINEN, Oulu (FI); Marko NIEMI, Oulu (FI)

(21) Appl. No.: 17/634,348

(22) PCT Filed: Jul. 7, 2020
(86) PCT No.: PCT/CN2020/100540

§ 371 Date: Feb. 10, 2022

Related U.S. Application Data
(60) Provisional application No. 62/886,435, filed on Aug. 14, 2019.

(51) Int. Cl. H04W 36/00; H04W 36/14

(52) U.S. Cl. CPC H04W 36/0066; H04W 36/0038; H04W 36/14

(57) ABSTRACT

A method for delivery of inter-system NAS security algorithms is provided to be executed by a User Equipment (UE). The method includes the following steps: sending a first REGISTRATION REQUEST message without information of inter-system capability of the UE to a first mobile communication system; and receiving a SECURITY MODE COMMAND message including NAS security algorithms to be used in a second mobile communication system from the first mobile communication system in response to sending the first REGISTRATION REQUEST message.

### CROSS REFERENCE TO RELATED APPLICATIONS

This Application claims priority of U.S. Provisional Application No. 62/886,435, filed on Aug. 14, 2019, the entirety of which is incorporated by reference herein.

### FIELD OF THE INVENTION

The application generally relates to Non-Access Stratum (NAS) security operations, and more particularly, to apparatuses and methods for delivery of inter-system NAS security algorithms.

### BACKGROUND

In a typical mobile communication environment, a User Equipment (UE) (also called a Mobile Station (MS)), such as a mobile telephone (also known as a cellular or cell phone), or a tablet Personal Computer (PC) with wireless communications capability, may communicate voice and/or data signals with one or more service networks. The wireless communications between the UE and the service networks may be performed using various Radio Access Technologies (RATs), which include the Global System for Mobile communications (GSM) technology, the General Packet Radio Service (GPRS) technology, the Enhanced Data rates for Global Evolution (EDGE) technology, the Wideband Code Division Multiple Access (WCDMA) technology, the Code Division Multiple Access 2000 (CDMA-2000) technology, the Time Division-Synchronous Code Division Multiple Access (TD-SCDMA) technology, the Worldwide Interoperability for Microwave Access (WiMAX) technology, the Long Term Evolution (LTE) technology, the LTE-Advanced (LTE-A) technology, the Time Division LTE (TD-LTE) technology, the fifth-generation (5G) New Radio (NR) technology, and others.

According to the 3rd Generation Partnership Project (3GPP) specifications and/or requirements in compliance with the 5G NR technology, an Access and Mobility Function (AMF) supporting N26 interface should provide the EPS NAS security algorithms in the SECURITY MODE COMMAND message to a UE if the UE supports S1 mode. However, the UE's S1 mode capability is indicated in a non-cleartext Information Element (IE) (i.e., an IE that cannot be sent unciphered), and non-cleartext IEs can only be sent to the AMF in the SECURITY MODE COMPLETE message. As a result, the AMF cannot provide the EPS NAS security algorithms to the UE at the initial security mode control procedure, and another security mode control procedure is required specifically for the purpose of delivering the EPS NAS security algorithms to the UE, as shown in FIG. 1. Disadvantageously, the extra signaling (i.e., the second security mode control procedure) will cause communication inefficiency and waste of power for both the UE and the AMF.

### SUMMARY

In order to solve the aforementioned problem, the present application proposes solutions to improve the communication efficiency for delivering inter-system NAS security algorithms (e.g., EPS NAS security algorithms) to a UE.

In a first aspect of the application, a method for delivery of inter-system NAS security algorithms, executed by a UE, is provided. The method comprises the following steps: sending a first REGISTRATION REQUEST message without information of inter-system capability of the UE to a first mobile communication system; and receiving a SECURITY MODE COMMAND message comprising NAS security algorithms to be used in a second mobile communication system from the first mobile communication system in response to sending the first REGISTRATION REQUEST message.

In a second aspect of the application, a method for delivery of inter-system NAS security algorithms, executed by a UE, is provided. The method comprises the following steps: receiving, from a first mobile communication system, NAS security algorithms to be used in a second mobile communication system in response to a handover or a reselection of the UE from the first mobile communication system to the second mobile communication system; and applying the NAS security algorithms to be used in the second mobile communication system after the handover or the reselection of the UE from the first mobile communication system to the second mobile communication system.

In a third aspect of the application, a method for delivery of inter-system NAS security algorithms, executed by a UE, is provided. The method comprises the following steps: sending a REGISTRATION REQUEST message without information of inter-system capability of the UE to a first mobile communication system; performing a first security mode control procedure with the first mobile communication system, wherein NAS security algorithms to be used in a second mobile communication system are not communicated to the UE during the first security mode control procedure in response to the REGISTRATION REQUEST message not comprising the information of inter-system capability of the UE; and receiving the NAS security algorithms to be used in the second mobile communication system from the first mobile communication system in response to the UE supporting inter-system capability.

Other aspects and features of the present application will become apparent to those with ordinarily skill in the art upon review of the following descriptions of specific embodiments of the methods for delivery of inter-system NAS security algorithms.

### BRIEF DESCRIPTION OF THE DRAWINGS

The application can be more fully understood by reading the subsequent detailed description and examples with references made to the accompanying drawings, wherein:

FIG. 1 is a message sequence chart illustrating a conventional practice for delivering the EPS NAS security algorithms to the UE;

FIG. 2 is a block diagram of a wireless communication environment according to an embodiment of the application;

FIG. 3 is a block diagram illustrating the UE 210 according to an embodiment of the application;

FIG. 4 is a flow chart illustrating the method for delivery of inter-system NAS security algorithms according to an embodiment of the application;

FIG. 5 is a message sequence chart illustrating the delivery of inter-system NAS security algorithms according to the embodiment of FIG. 4;

FIG. 6 is a flow chart illustrating the method for delivery of inter-system NAS security algorithms according to another embodiment of the application;

FIGS. 7A˜7B show a message sequence chart illustrating the delivery of inter-system NAS security algorithms according to the embodiment of FIG. 6;

FIG. 8 is a flow chart illustrating the method for delivery of inter-system NAS security algorithms according to another embodiment of the application; and

FIG. 9 is a message sequence chart illustrating the delivery of inter-system NAS security algorithms according to the embodiment of FIG. 8.

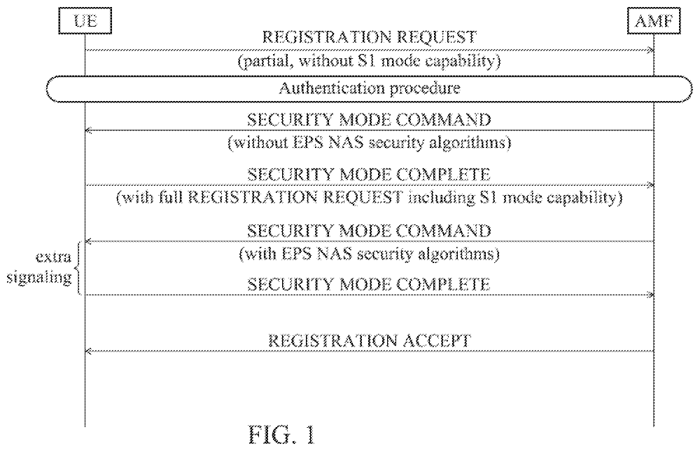

### DETAILED DESCRIPTION

The following description is made for the purpose of illustrating the general principles of the application and should not be taken in a limiting sense. It should be understood that the embodiments may be realized in software, hardware, firmware, or any combination thereof. The terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

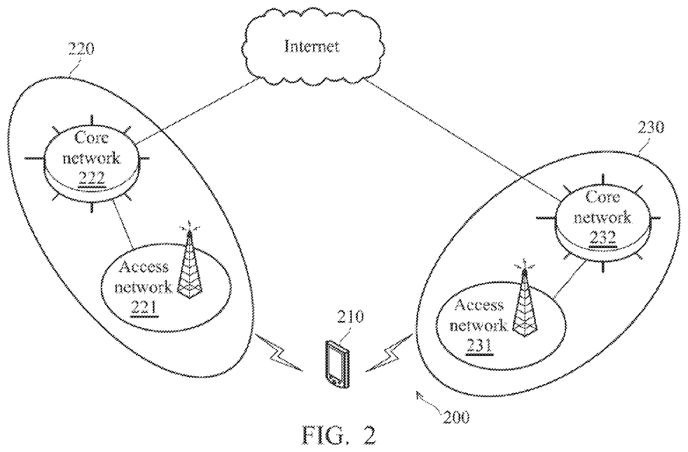

FIG. 2 is a block diagram of a wireless communication environment according to an embodiment of the application.

As shown in FIG. 2, the wireless communication environment 200 includes a User Equipment (UE) 210 and two mobile communication systems 220 and 230.

The UE 210 may be a feature phone, a smartphone, a tablet Personal Computer (PC), a laptop computer, or any wireless communication device supporting the RATs utilized by the mobile communication systems 220 and 230. The UE 210 may wirelessly communicate with one or both the mobile communication systems 220 and 230 for obtaining mobile services.

In one embodiment, the RAT utilized by the mobile communication system 220 is more advanced than the RAT utilized by the mobile communication system 230. For example, the mobile communication system 220 may be a 5G System (5GS) (e.g., a 5G NR network), and the mobile communication system 230 may be an Evolve Packet System (EPS) (e.g., an LTE/LTE-A/TD-LTE network).

Specifically, the mobile communication system 220 may include an access network 221 and a core network 222, while the mobile communication system 230 may include an access network 231 and a core network 232. The access networks 221 and 231 are responsible for processing radio signals, terminating radio protocols, and connecting the UE 210 with the core networks 222 and 232, respectively. The core networks 222 and 232 are responsible for performing mobility management, network-side authentication, and interfaces with public/external networks (e.g., the Internet).

The access networks 221 and 231 and the core networks 222 and 232 may each include one or more network nodes for carrying out said functions.

For example, if the mobile communication system 220 is a 5GS (e.g., a 5G NR network), the access network 221 may be a Next Generation Radio Access Network (NG-RAN) which includes at least a gNB or Transmission Reception Point (TRP), and the core network 222 may be a Next Generation Core Network (NG-CN) which includes various network functions, including an Access and Mobility Function (AMF), Session Management Function (SMF), Policy Control Function (PCF), Application Function (AF), Authentication Server Function (AUSF), User Plane Function (UPF), and User Data Management (UDM), wherein each network function may be implemented as a network element on a dedicated hardware, or as a software instance running on a dedicated hardware, or as a virtualized function instantiated on an appropriate platform, e.g., a cloud infrastructure.

The AMF provides UE-based authentication, authorization, mobility management, etc. The SMF is responsible for session management and allocates Internet Protocol (IP) addresses to UEs. It also selects and controls the UPF for data transfer. If a UE has multiple sessions, different SMFs may be allocated to each session to manage them individually and possibly provide different functions per session.

The AF provides information on the packet flow to PCF responsible for policy control in order to support Quality of Service (QoS). Based on the information, the PCF determines policies about mobility and session management to make the AMF and the SMF operate properly. The AUSF stores data for authentication of UEs, while the UDM stores subscription data of UEs.

For example, if the mobile communication system 230 is an EPS (e.g., an LTE/LTE-A/TD-LTE network), the access network 231 may be an Evolved-UTRAN (E-UTRAN) which includes at least an evolved NB (eNB) (e.g., a macro eNB, femto eNB, or pico eNB), and the core network 232 may be an Evolved Packet Core (EPC) which includes a Home Subscriber Server (HSS), Mobility Management Entity (MME), Serving Gateway (S-GW), and Packet Data Network Gateway (PDN-GW or P-GW).

More specifically, interworking between the mobile communication systems 220 and 230 is supported. For example, if the mobile communication systems 220 and 230 are a 5GS and an EPS, respectively, the AMF of the NG-CN may support the N26 interface with the MME of the EPC to enable interworking between the NG-CN and the EPC, and the UE 210 may support the S1 mode and/or the N1 mode based on its inter-system capability.

It should be understood that the description of the wireless communication environment 200 is for illustrative purposes only and is not intended to limit the scope of the application. For example, the mobile communication system 220 may be a 6G system and the mobile communication system 230 may be a 5G system, if interworking between the 6G and 5G core networks is supported.

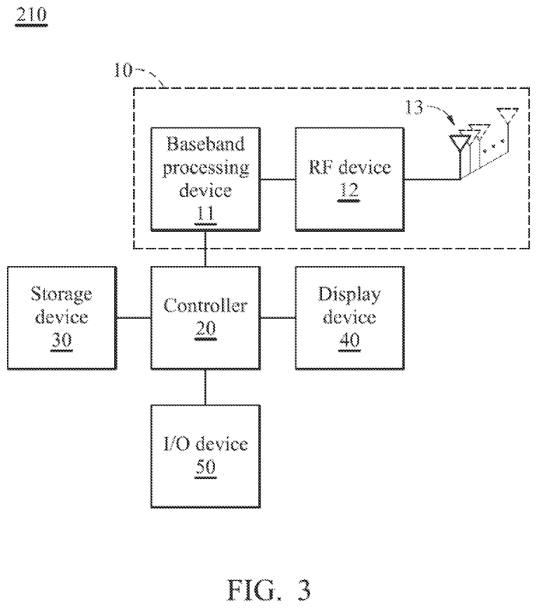

FIG. 3 is a block diagram illustrating the UE 210 according to an embodiment of the application.

As shown in FIG. 3, the UE 210 may include a wireless transceiver 10, a controller 20, a storage device 30, a display device 40, and an Input/Output (I/O) device 50.

The wireless transceiver 10 is configured to perform wireless transmission and reception to and from the access network 221 and/or the access network 231.

Specifically, the wireless transceiver 10 may include a baseband processing device 11, a Radio Frequency (RF) device 12, and antenna 13, wherein the antenna 13 may include an antenna array for beamforming.

The baseband processing device 11 is configured to perform baseband signal processing and control the communications between subscriber identity card(s) (not shown) and the RF device 12. In one embodiment, the subscriber identity card may be a Subscriber Identity Module (SIM) card or a Universal SIM (USIM) card, and may be inserted into a socket of the UE 210. In another embodiment, the subscriber identity card may be a virtual SIM/USIM or soft SIM/USIM, and may be embedded inside the UE 210 (e.g., may be written into the storage device 30).

The baseband processing device 11 may contain multiple hardware components to perform the baseband signal processing, including Analog-to-Digital Conversion (ADC)/Digital-to-Analog Conversion (DAC), gain adjusting, modulation/demodulation, encoding/decoding, and so on.

The RF device 12 may receive RF wireless signals via the antenna 13, convert the received RF wireless signals to baseband signals, which are processed by the baseband processing device 11, or receive baseband signals from the baseband processing device 11 and convert the received baseband signals to RF wireless signals, which are later transmitted via the antenna 13.

The RF device 12 may also contain multiple hardware devices to perform radio frequency conversion. For example, the RF device 12 may include a mixer to multiply the baseband signals with a carrier oscillated in the radio frequency of the supported cellular technologies, wherein the radio frequency may be any radio frequency (e.g., 30 GHz˜300 GHz for mmWave) utilized in the 5G NR technology, or may be 900 MHz, 2100 MHz, or 2.6 GHz utilized in LTE/LTE-A/TD-LTE technology, or another radio frequency, depending on the RAT in use.

The controller 20 may be a general-purpose processor, a Micro Control Unit (MCU), an application processor, a Digital Signal Processor (DSP), a Graphics Processing Unit (GPU), a Holographic Processing Unit (HPU), a Neural Processing Unit (NPU), or the like, which includes various circuits for providing the functions of data processing and computing, controlling the wireless transceiver 10 for wireless transmission and reception to and from the access network 221 and/or the access network 231, storing and retrieving data (e.g., inter-system NAS security algorithms) to and from the storage device 30, sending a series of frame data (e.g. representing text messages, graphics, images, etc.) to the display device 40, and receiving user inputs or outputting signals via the I/O device 50.

In particular, the controller 20 coordinates the aforementioned operations of the wireless transceiver 10, the storage device 30, the display device 40, and the I/O device 50 for performing the method for delivery of inter-system NAS security algorithms.

In another embodiment, the controller 20 may be incorporated into the baseband processing device 11, to serve as a baseband processor.

As will be appreciated by persons skilled in the art, the circuits of the controller 20 will typically include transistors that are configured in such a way as to control the operation of the circuits in accordance with the functions and operations described herein. As will be further appreciated, the specific structure or interconnections of the transistors will typically be determined by a compiler, such as a Register Transfer Language (RTL) compiler. RTL compilers may be operated by a processor upon scripts that closely resemble assembly language code, to compile the script into a form that is used for the layout or fabrication of the ultimate circuitry. Indeed, RTL is well known for its role and use in the facilitation of the design process of electronic and digital systems.

The storage device 30 may be a non-transitory machine-readable storage medium, including a Universal Integrated Circuit Card (UICC) (e.g., SIM/USIM), a memory, such as a FLASH memory or a Non-Volatile Random Access Memory (NVRAM), or a magnetic storage device, such as a hard disk or a magnetic tape, or an optical disc, or any combination thereof for storing data (e.g., inter-system NAS security algorithms), instructions, and/or program code of applications, communication protocols, and/or the method for delivery of inter-system NAS security algorithms.

The display device 40 may be a Liquid-Crystal Display (LCD), a Light-Emitting Diode (LED) display, an Organic LED (OLED) display, or an Electronic Paper Display (EPD), etc., for providing a display function. Alternatively, the display device 40 may further include one or more touch sensors disposed thereon or thereunder for sensing touches, contacts, or approximations of objects, such as fingers or styluses.

The I/O device 50 may include one or more buttons, a keyboard, a mouse, a touch pad, a video camera, a microphone, and/or a speaker, etc., to serve as the Man-Machine Interface (MMI) for interaction with users.

It should be understood that the components described in the embodiment of FIG. 3 are for illustrative purposes only and are not intended to limit the scope of the application. For example, the UE 210 may include more components, such as a power supply, and/or a Global

Positioning System (GPS) device, wherein the power supply may be a mobile/replaceable battery providing power to all the other components of the UE 210, and the GPS device may provide the location information of the UE 210 for use by some location-based services or applications. Alternatively, the UE 210 may include fewer components. For example, the UE 210 may not include the display device 40 and/or the I/O device 50.

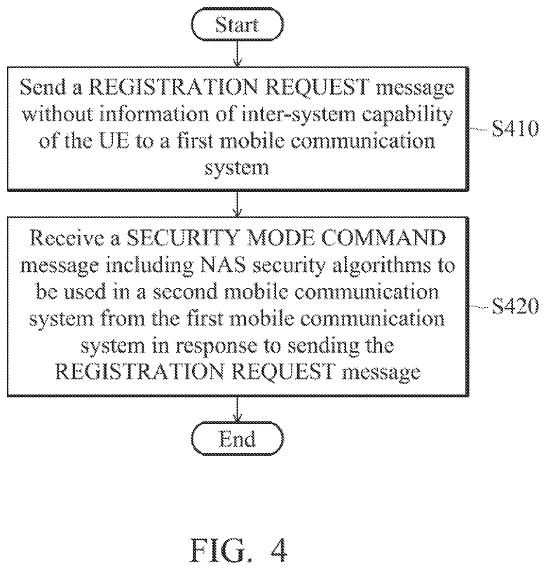

FIG. 4 is a flow chart illustrating the method for delivery of inter-system NAS security algorithms according to an embodiment of the application.

In this embodiment, the method for delivery of inter-system NAS security algorithms is applied to and executed by a UE (e.g., the UE 210).

To begin with, the UE sends a REGISTRATION REQUEST message without information of inter-system capability of the UE to a first mobile communication system (step S410).

In one embodiment, the REGISTRATION REQUEST message does not include the 5GMM capability Information Element (IE) which indicates the information of inter-system capability of the UE, in response to the first mobile communication system being a 5GS.

Specifically, the SGMM capability IE is a non-cleartext IE, and the REGISTRATION REQUEST message is an initial NAS message which includes cleartext IEs only. The SGMM capability IE may include a predetermined bit (e.g., a “S1 mode” bit) indicating whether the UE supports the S1 mode (i.e., the inter-system capability).

Next, the UE receives a SECURITY MODE COMMAND message including NAS security algorithms to be used in a second mobile communication system from the first mobile communication system in response to sending the REGISTRATION REQUEST message (step S420), and the method ends.

Specifically, the NAS security algorithms to be used in the second mobile communication system may be selected by the first mobile communication system. For example, the NAS security algorithms to be used in the second mobile communication system may be selected by an AMF in response to the first mobile communication system being a 5GS, or may be selected by any suitable entity of the first mobile communication system.

In one embodiment, the NAS security algorithms to be used in the second mobile communication system may be EPS NAS security algorithms in response to the second mobile communication system being an EPS. For example, the NAS security algorithms may refer to the selected EPS NAS security algorithms specified in release 16 of the 3GPP Technical Specification (TS) 24.501.

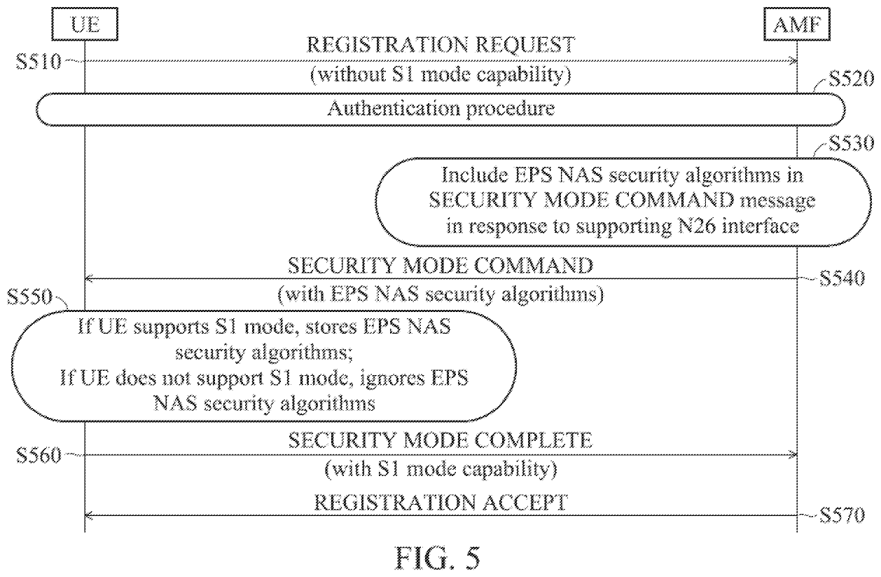

FIG. 5 is a message sequence chart illustrating the delivery of inter-system NAS security algorithms according to the embodiment of FIG. 4.

In step S510, a registration procedure is started by the UE sending a REGISTRATION REQUEST message without S1 mode capability to the AMF. Specifically, the REGISTRATION REQUEST message includes cleartext IEs only. That is, the REGISTRATION REQUEST message does not include non-cleartext IEs, including the 5GMM capability IE that includes the S1 mode capability.

In step S520, if the AMF is not able to find the NAS security context locally or from the last visited AMF (the AMF that is last visited by the UE), or if the AMF of the new PLMN is able to find the NAS security context locally or from the last visited AMF but it decides not to use the NAS security context, or if the integrity check of the received REGISTRATION REQUEST message fails, then the AMF may initiate an authentication procedure with the UE.

In step S530, the AMF includes the EPS NAS security algorithms in a SECURITY MODE COMMAND message in response to the AMF supporting the N26 interface. For example, the AMF may include the selected EPS NAS security algorithms IE in the SECURITY MODE COMMAND message to indicate the EPS NAS security algorithms.

In step S540, the AMF sends the SECURITY MODE COMMAND message including the EPS NAS security algorithms to the UE.

In step S550, the UE stores the EPS NAS security algorithms if it supports the S1 mode; otherwise, the UE ignores the EPS NAS security algorithms if it does not support the S1 mode.

In step S560, the UE sends a SECURITY MODE COMPLETE message with the S1 mode capability to the AMF. Specifically, the SECURITY MODE COMPLETE message includes the full REGISTRATION REQUEST message which includes both the cleartext IEs and non-cleartext IEs, wherein the non-cleartext IEs include the 5GMM capability IE with the S1 mode bit set to “S1 mode supported”.

In step S570, the AMF sends a REGISTRATION ACCEPT message to the UE to complete the registration procedure.

In view of the embodiments of FIGS. 4-5, it should be appreciated that the present application improves the communication efficiency for delivering inter-system NAS security algorithms to a UE, by enabling the AMF supporting the N26 interface to always send the inter-system NAS security algorithms in the SECURITY MODE COMMAND message to the UE, regardless of whether the AMF has received the S1 mode capability of the UE or not. Advantageously, a second security mode control procedure will not be triggered specifically for the purpose of delivering the inter-system NAS security algorithms to the UE.

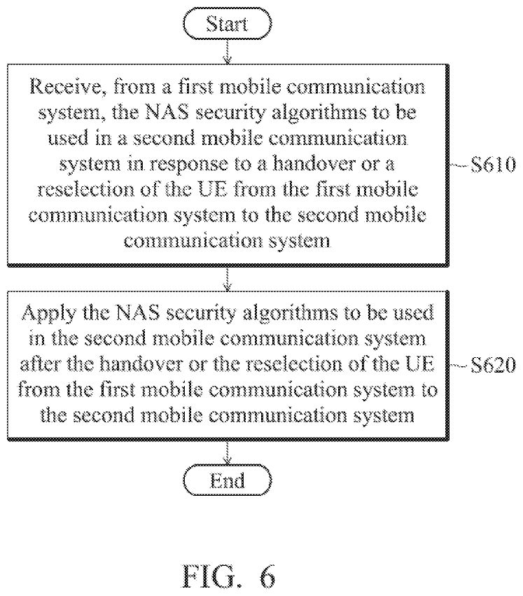

FIG. 6 is a flow chart illustrating the method for delivery of inter-system NAS security algorithms according to another embodiment of the application.

In this embodiment, the method for delivery of inter-system NAS security algorithms is applied to and executed by a UE (e.g., the UE 210).

To begin with, the UE receives, from a first mobile communication system, the NAS security algorithms to be used in a second mobile communication system in response to a handover or a reselection of the UE from the first mobile communication system to the second mobile communication system (step S610).

Specifically, the NAS security algorithms to be used in the second mobile communication system may be selected by the first mobile communication system. For example, the NAS security algorithms to be used in the second mobile communication system may be selected by an AMF in response to the first mobile communication system being a 5GS, or may be selected by any suitable entity of the first mobile communication system.

In one embodiment, the NAS security algorithms to be used in the second mobile communication system may be EPS NAS security algorithms in response to the second mobile communication system being an EPS. For example, the NAS security algorithms may refer to the selected EPS NAS security algorithms specified in release 16 of the 3GPP TS 24.501.

Specifically, if the UE is in a connected mode (e.g., the RRC_CONNECTED mode), the NAS security algorithms to be used in the second mobile communication system may be received via a handover command (e.g., a RRCConnectionReconfiguration message) from the first mobile communication system.

Alternatively, if the UE is in an idle mode (e.g., the RRC_IDLE mode), the NAS security algorithms to be used in the second mobile communication system are received via a security mode control procedure with the second mobile communication system after the reselection.

Next, the UE applies the NAS security algorithms to be used in the second mobile communication system after the handover or the reselection of the UE from the first mobile communication system to the second mobile communication system (step S620), and the method ends.

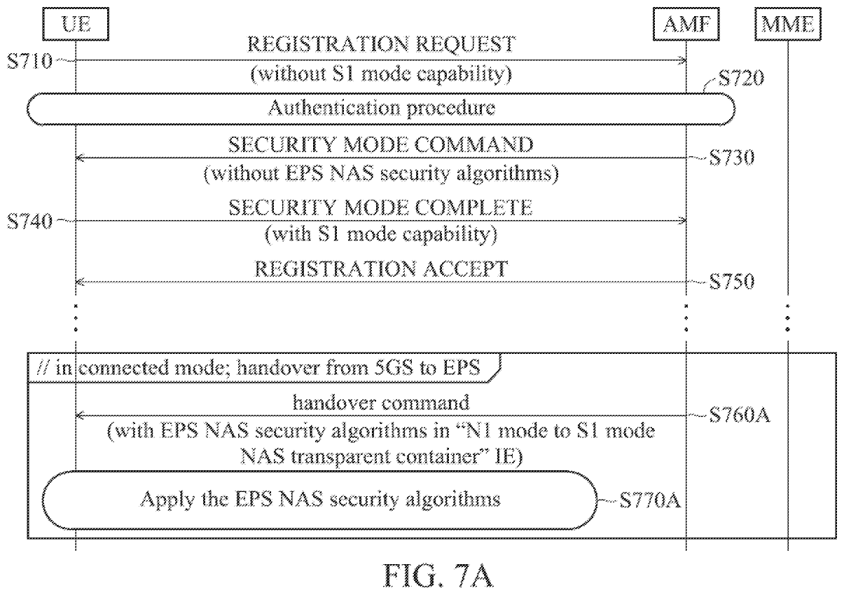

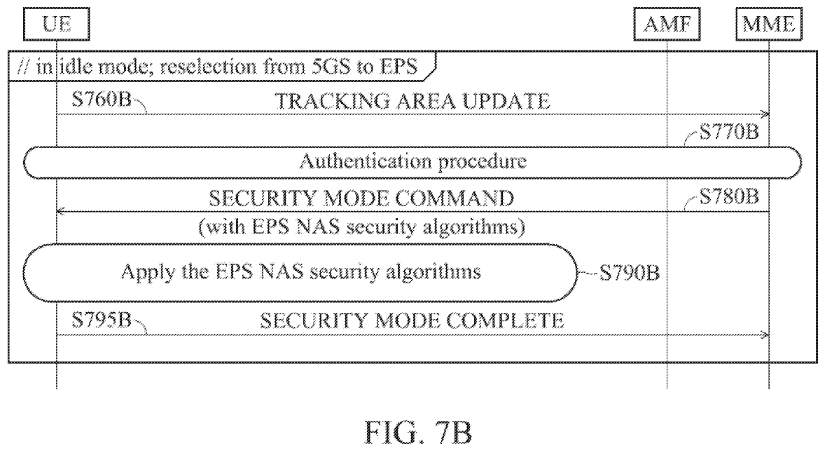

FIGS. 7A˜7B show a message sequence chart illustrating the delivery of inter-system NAS security algorithms according to the embodiment of FIG. 6.

In step S710, a registration procedure is started by the UE sending a REGISTRATION REQUEST message without S1 mode capability to the AMF. Specifically, the REGISTRATION REQUEST message includes cleartext IEs only. That is, the REGISTRATION REQUEST message does not include non-cleartext IEs, including the 5GMM capability IE that includes the S1 mode capability.

In step S720, if the AMF is not able to find the NAS security context locally or from the last visited AMF (the AMF that is last visited by the UE), or if the AMF of the new PLMN is able to find the NAS security context locally or from the last visited AMF but it decides not to use the NAS security context, or if the integrity check of the received REGISTRATION REQUEST message fails, then the AMF may initiate an authentication procedure with the UE.

In step S730, the AMF sends a SECURITY MODE COMMAND message without the EPS NAS security algorithms (e.g., a SECURITY MODE COMMAND message not including the selected EPS NAS security algorithms IE) to the UE due to the unavailability of the S1 mode capability of the UE.

In step S740, the UE sends a SECURITY MODE COMPLETE message with the S1 mode capability to the AMF. Specifically, the SECURITY MODE COMPLETE message includes the full REGISTRATION REQUEST message which includes both the cleartext IEs and non-cleartext IEs, wherein the non-cleartext IEs include the 5GMM capability IE with the S1 mode bit set to “S1 mode supported”.

In step S750, the AMF sends a REGISTRATION ACCEPT message to the UE to complete the registration procedure.

After the registration procedure, steps S760A˜S770A may be performed in response to a handover of the UE from 5GS to EPS when the UE is in the connected mode (e.g., the RRC_CONNECTED mode). Alternatively, steps S760B˜S795B may be performed in response to a reselection of the UE from 5GS to EPS when the UE is in the idle mode (e.g., the RRC_IDLE mode).

In step S760A, the AMF may send a handover command to the UE, wherein the handover command includes the “N1 mode to S1 mode NAS transparent container” IE which specifically includes the EPS NAS security algorithms. For example, the “N1 mode to S1 mode NAS transparent container” IE may include the selected EPS NAS security algorithms IE which indicates the EPS NAS security algorithms.

In step S770A, the UE applies the EPS NAS security algorithms received from the handover command.

In step S760B, the UE may send a TRACKING AREA UPDATE message to the MME of the EPS.

In step S770B, the MME may initiate an authentication procedure with the UE.

In step S780B, the MME may initiate a second security mode control procedure with the UE by sending a SECURITY MODE COMMAND message to the UE, wherein the SECURITY MODE COMMAND message specifically includes the EPS NAS security algorithms. For example, the SECURITY MODE COMMAND message may include the selected EPS NAS security algorithms IE which indicates the EPS NAS security algorithms.

In step S790B, the UE applies the EPS NAS security algorithms received from the SECURITY MODE COMMAND message of the second security mode control procedure.

In step S795B, the UE sends a SECURITY MODE COMPLETE message to the MME to complete the security mode control procedure.

In view of the embodiments of FIGS. 6˜7, it should be appreciated that the present application improves the communication efficiency for delivering inter-system NAS security algorithms to a UE, by enabling the AMF/MME supporting the N26 interface to send the inter-system NAS security algorithms to the UE when a handover or reselection of the UE from 5GS to EPS occurs. Advantageously, the inter-system NAS security algorithms is delivered only when needed, and extra signaling for delivering the inter-system NAS security algorithms is required only for the UE supporting the S1 mode, instead of all registered UEs.

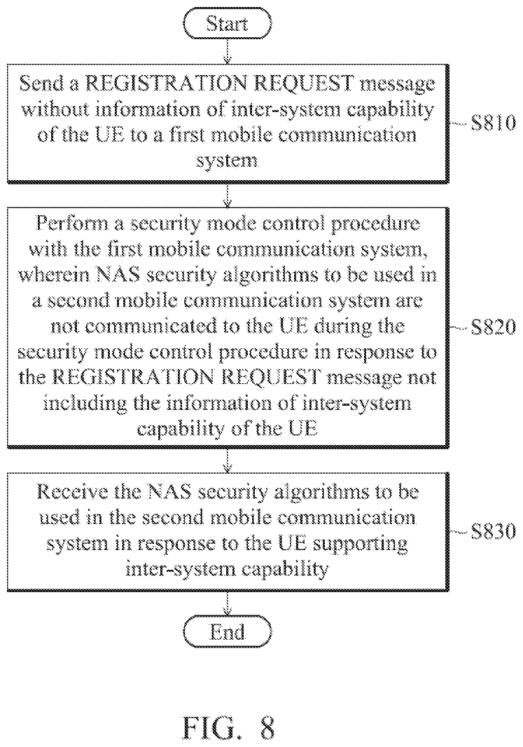

FIG. 8 is a flow chart illustrating the method for delivery of inter-system NAS security algorithms according to another embodiment of the application.

In this embodiment, the method for delivery of inter-system NAS security algorithms is applied to and executed by a UE (e.g., the UE 210).

To begin with, the UE sends a REGISTRATION REQUEST message without information of inter-system capability of the UE to a first mobile communication system (step S810).

In one embodiment, the REGISTRATION REQUEST message does not include the 5GMM capability IE which indicates the information of inter-system capability of the UE, in response to the first mobile communication system being a 5GS.

Specifically, the 5GMM capability IE is a non-cleartext IE, and the REGISTRATION REQUEST message is an initial NAS message which includes cleartext IEs only. The 5GMM capability IE may include a predetermined bit (e.g., a “S1 mode” bit) indicating whether the UE supports the S1 mode (i.e., the inter-system capability).

Next, the UE performs a security mode control procedure with the first mobile communication system, wherein NAS security algorithms to be used in a second mobile communication system are not communicated to the UE during the security mode control procedure in response to the REGISTRATION REQUEST message not including the information of inter-system capability of the UE (step S820).

Specifically, the NAS security algorithms to be used in the second mobile communication system may be selected by the first mobile communication system. For example, the NAS security algorithms to be used in the second mobile communication system may be selected by an AMF in response to the first mobile communication system being a 5GS, or may be selected by any suitable entity of the first mobile communication system.

In one embodiment, the NAS security algorithms to be used in the second mobile communication system may be EPS NAS security algorithms in response to the second mobile communication system being an EPS. For example, the NAS security algorithms may refer to the selected EPS NAS security algorithms specified in release 16 of the 3GPP TS 24.501.

After the security mode control procedure, the UE receives the NAS security algorithms to be used in the second mobile communication system in response to the UE supporting inter-system capability (step S830), and the method ends.

In one embodiment, the NAS security algorithms to be used in the second mobile communication system may be received via a CONFIGURATION UPDATE COMMAND message or a REGISTRATION ACCEPT message, or a SECURITY MODE COMMAND message of a second security mode control procedure.

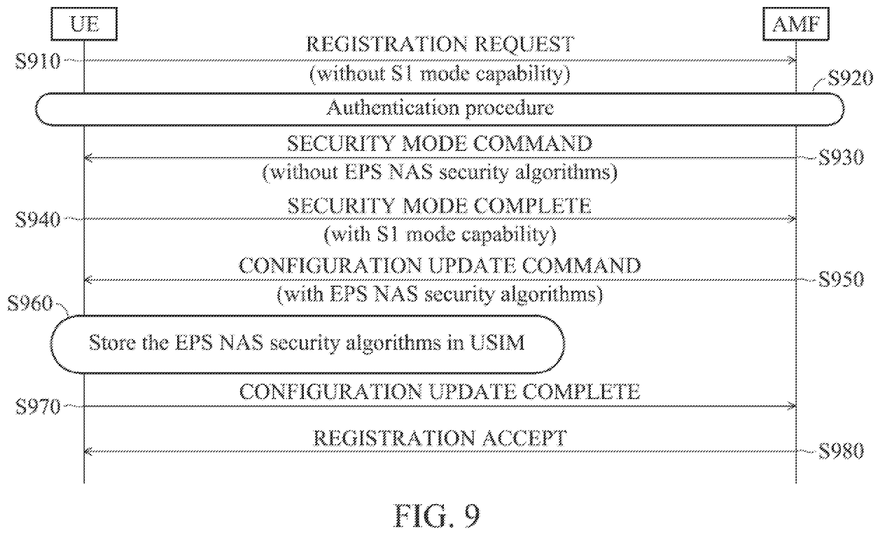

FIG. 9 is a message sequence chart illustrating the delivery of inter-system NAS security algorithms according to the embodiment of FIG. 8.

In step S910, a registration procedure is started by the UE sending a REGISTRATION REQUEST message without S1 mode capability to the AMF. Specifically, the REGISTRATION REQUEST message includes cleartext IEs only. That is, the REGISTRATION REQUEST message does not include non-cleartext IEs, including the 5GMM capability IE that includes the S1 mode capability.

In step S920, if the AMF is not able to find the NAS security context locally or from the last visited AMF (the AMF that is last visited by the UE), or if the AMF of the new PLMN is able to find the NAS security context locally or from the last visited AMF but it decides not to use the NAS security context, or if the integrity check of the received REGISTRATION REQUEST message fails, then the AMF may initiate an authentication procedure with the UE.

In step S930, the AMF sends a SECURITY MODE COMMAND message without the EPS NAS security algorithms (e.g., a SECURITY MODE COMMAND message not including the selected EPS NAS security algorithms IE) to the UE due to the unavailability of the S1 mode capability of the UE.

In step S940, the UE sends a SECURITY MODE COMPLETE message with the S1 mode capability to the AMF. Specifically, the SECURITY MODE COMPLETE message includes the full REGISTRATION REQUEST message which includes both the cleartext IEs and non-cleartext IEs, wherein the non-cleartext IEs include the 5GMM capability IE with the S1 mode bit set to “S1 mode supported”.

In step S950, the AMF sends a CONFIGURATION UPDATE COMMAND message including the EPS NAS security algorithms to the UE due to the S1 mode capability of the UE being available. For example, the CONFIGURATION UPDATE COMMAND message may include the selected EPS NAS security algorithms IE to indicate the EPS NAS security algorithms.

In step S960, the UE stores the EPS NAS security algorithms received from the CONFIGURATION UPDATE COMMAND message in the USIM.

In step S970, the UE sends a CONFIGURATION UPDATE COMPLETE message to the AMF.

In step S980, the AMF sends a REGISTRATION ACCEPT message to the UE to complete the registration procedure.

Please note that, the EPS NAS security algorithms may be communicated to the UE via other signaling messages (e.g., a REGISTRATION ACCEPT message or a SECURITY MODE COMMAND message), and they may be communicated to the UE prior to the registration procedure, or after the registration procedure when the EPS NAS security algorithms have been updated by the AMF.

In view of the embodiments of FIGS. 8˜9, it should be appreciated that the present application improves the communication efficiency for delivering inter-system NAS security algorithms to a UE, by enabling the AMF supporting the N26 interface to send the inter-system NAS security algorithms to only the UE supporting the S1 mode. Advantageously, there will be no extra signaling for delivering the inter-system NAS security algorithms to UEs not supporting the S1 mode, and network bandwidth can be saved.

While the application has been described by way of example and in terms of preferred embodiment, it should be understood that the application is not limited thereto. Those who are skilled in this technology can still make various alterations and modifications without departing from the scope and spirit of this application. Therefore, the scope of the present application shall be defined and protected by the following claims and their equivalents.

Use of ordinal terms such as “first”, “second”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

1. A method for delivery of inter-system Non-Access Stratum (NAS) security algorithms, executed by a User Equipment (UE), the method comprising:
sending a first REGISTRATION REQUEST message without information of inter-system capability of the UE to a first mobile communication system; and
receiving a SECURITY MODE COMMAND message comprising NAS security algorithms to be used in a second mobile communication system from the first mobile communication system in response to sending the first REGISTRATION REQUEST message.

2. The method of claim 1, wherein the first REGISTRATION REQUEST message does not comprise a 5GMM capability Information Element (IE) which indicates the information of inter-system capability of the UE, in response to the first mobile communication system being a 5G System (5GS).

3. The method of claim 1, further comprising:
storing the NAS security algorithms to be used in the second mobile communication system in response to the UE supporting the inter-system capability.

4. The method of claim 1, further comprising:
ignoring the NAS security algorithms to be used in the second mobile communication system in response to the UE not supporting the inter-system capability.

5. The method of claim 1, The method of claim 1, wherein the NAS security algorithms to be used in the second mobile communication system are Evolve Packet System (EPS) NAS security algorithms in response to the second mobile communication system being an EPS.

6. The method of claim 1, wherein the first REGISTRATION REQUEST message is an initial NAS message which comprises cleartext IEs.

7. A method for delivery of inter-system Non-Access Stratum (NAS) security algorithms, executed by a User Equipment (UE), the method comprising:
receiving, from a first mobile communication system, NAS security algorithms to be used in a second mobile communication system in response to a handover or a reselection of the UE from the first mobile communication system to the second mobile communication system; and
applying the NAS security algorithms to be used in the second mobile communication system after the handover or the reselection of the UE from the first mobile communication system to the second mobile communication system.

8. The method of claim 7, wherein the NAS security algorithms to be used in the second mobile communication system are received via a handover command from the first mobile communication system, in response to the UE being in a connected mode.

9. The method of claim 7, wherein the NAS security algorithms to be used in the second mobile communication system are received via a second security mode control procedure with the second mobile communication system after the reselection, in response to the UE being in an idle mode.

10. The method of claim 7, wherein the NAS security algorithms to be used in the second mobile communication system are Evolve Packet System (EPS) NAS security algorithms in response to the second mobile communication system being an EPS.

11. The method of claim 7, wherein the first REGISTRATION REQUEST message is an initial NAS message which comprises cleartext IEs.

12. A method for delivery of inter-system Non-Access Stratum (NAS) security algorithms, executed by a User Equipment (UE), the method comprising:
sending a REGISTRATION REQUEST message without information of inter-system capability of the UE to a first mobile communication system;
performing a first security mode control procedure with the first mobile communication system, wherein NAS security algorithms to be used in a second mobile communication system are not communicated to the UE during the first security mode control procedure in response to the REGISTRATION REQUEST message not comprising the information of inter-system capability of the UE; and
receiving the NAS security algorithms to be used in the second mobile communication system from the first mobile communication system in response to the UE supporting inter-system capability.

13. The method of claim 12, further comprising:
storing the NAS security algorithms to be used in the second mobile communication system in a Universal Subscriber Identity Module (USIM) or a non-volatile memory of the UE.

14. The method of claim 12, wherein the NAS security algorithms to be used in the second mobile communication system is received via a CONFIGURATION UPDATE COMMAND message or a REGISTRATION ACCEPT message, or a SECURITY MODE COMMAND message of a second security mode control procedure.

15. The method of claim 12, wherein a registration procedure with the first mobile communication system is started by sending the REGISTRATION REQUEST message, and the NAS security algorithms to be used in the second mobile communication system is received prior to or during the registration procedure.

16. The method of claim 12, wherein the REGISTRATION REQUEST message does not comprise a 5GMM capability Information Element (IE) which indicates the information of inter-system capability of the UE, in response to the first mobile communication system being a 5G System (5GS).

17. The method of claim 12, wherein the NAS security algorithms to be used in the second mobile communication system are Evolve Packet System (EPS) NAS security algorithms IE in response to the second mobile communication system being an EPS.

18. The method of claim 12, wherein the REGISTRATION REQUEST message is an initial NAS message which comprises cleartext IEs.
